(19) United States
(12) Patent Application Publication
(10) Pub. No.: US 2026/0333109 A1
(43) Pub. Date: Oct. 22, 2026

(54) COMMUNICATION APPARATUS, CONTROL METHOD, AND STORAGE MEDIUM

(71) Applicant: CANON KABUSHIKI KAISHA, Tokyo (JP)

(72) Inventor: KOHTARO KOIKE, Kanagawa (JP)

(21) Appl. No.: 19/642,393

(22) Filed: Apr. 8, 2026

(30) Foreign Application Priority Data
Apr. 17, 2025 (JP) 2025-067907

(51) Int. Cl. H04W 28/02; H04W 76/14

(52) U.S. Cl. CPC H04W 28/0221; H04W 76/14

(57) ABSTRACT

A communication apparatus configured to establish a direct connection with another communication apparatus and construct a network related to the direct connection, includes at least one memory that stores a set of instructions, and at least one processor that executes the instructions, the instructions, when executed, causing the communication apparatus to perform operations including receiving, from a first other communication apparatus, first information indicating whether the first other communication apparatus supports power saving based on a reduction in a wake time.

### BACKGROUND

### Field of the Technology

The present disclosure relates to a communication apparatus, a control method, and a storage medium.

### Description of the Related Art

With an increase in the amount of data to be communicated in recent years, a communication technique using a wireless local area network (LAN) or the like has been developed. As a major communication standard using a wireless LAN, the Institute of Electrical and Electronics Engineers (IEEE) 802.11 standard series is known. The IEEE 802.11 standard series includes standards such as IEEE 802.11a/b/g/n/ac/ax and the like. For example, IEEE 802.11ax, which is the latest standard, standardizes a technique for improving the communication speed in a congested situation in addition to high peak throughput, namely a maximum of 9.6 gigabits per second (Gbps), using orthogonal frequency-division multiple access (OFDMA).

On the other hand, the Wi-Fi® Alliance, which formulates an authentication program for a wireless LAN device, formulates the Wi-Fi Direct (WFD) standard, which defines a procedure for exchanging communication parameters between stations (STAs) in a wireless LAN and establishing a communication link between the STAs not via an access point (AP). Wi-Fi is the abbreviation of Wireless Fidelity. AP is the abbreviation of access point. STA is the abbreviation of station. WFD is the abbreviation of Wi-Fi Direct®. An STA is also occasionally referred to as a "non-AP STA". WFD communication is an example of peer-to-peer (P2P) communication or device-to-device (D2D) or direct connection communication.

The Wi-Fi® Alliance also formulates the Wi-Fi Aware standard, which is a standard for searching for a service provided by an apparatus. Japanese Patent Laid-Open No. 2019-201427 describes a technique for detecting a communication apparatus using the provisions of the Wi-Fi Aware standard.

From the IEEE 802.11ah standard onward, Target Wake Time (TWT) for the purpose of power saving and low-latency communication has been introduced. The introduction of TWT enables an AP and an STA to communicate with each other during a period determined in advance between the AP and the STA. A period other than the period determined in advance is set as a period when transmission and reception (e.g., communication) are not performed, whereby these communication apparatuses can achieve power saving. Hereinafter, the period determined in advance is referred to as a "TWT service period (SP)".

The TWT SP may also be referred to as a "wake period (or wake duration)", an "awake state period", an "active state period", or the like.

Wi-Fi Direct Release 2 (WFD R2) considers TWT-based P2P power management as a power saving function in TWT. A device that does not support TWT-based P2P power management is not allowed to participate in a P2P group that performs TWT-based P2P power management. Japanese Unexamined Patent Application Publication No. 2023-547311 describes a technique regarding TWT for P2P communication.

However, a specific mechanism for preventing a device from participating in a P2P group that performs TWT-based P2P power management is not defined and clarified. If such a mechanism is not clarified, a device that does not support TWT-based P2P power management may accidentally participate in a P2P group. In this case, a predetermined device (e.g., a group owner) cannot operate in TWT-based P2P power management, and operates even during a period when the predetermined device should normally sleep. Thus, power consumption may increase due to this operation.

### SUMMARY

The present disclosure is directed to providing a technique for preventing or reducing an increase in power consumption.

According to an aspect of the present disclosure, a communication apparatus configured to establish a direct connection with another communication apparatus and construct a network related to the direct connection, includes at least one memory that stores a set of instructions, and at least one processor that executes the instructions, the instructions, when executed, causing the communication apparatus to perform operations including receiving, from a first other communication apparatus, first information indicating whether the first other communication apparatus supports power saving based on a reduction in a wake time.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of a wireless communication system according to an embodiment.

FIG. 2 is a diagram illustrating an example of a hardware configuration of a communication apparatus according to the embodiment.

FIG. 3 is a diagram illustrating an example of a functional configuration of the communication apparatus according to the embodiment.

FIG. 4 is a flowchart illustrating an example of a flow of processing performed by the communication apparatus according to example 1.

FIG. 5 is a diagram illustrating an example of a configuration of a Target Wake Time (TWT) element according to the embodiment.

FIG. 6 is a flowchart illustrating an example of a flow of processing performed by the communication apparatus according to example 2.

### DESCRIPTION OF THE EMBODIMENTS

Embodiments will be described in detail below with reference to the attached drawings. The following embodiments do not limit the subject matter described in the appended claims. Although a plurality of features are described in the embodiments, not all the plurality of features are essential for the present disclosure, and the plurality of features may be optionally combined together. Further, in the attached drawings, the same or similar components are designated by the same reference numbers, and are not redundantly described.

### Embodiment

### System Configuration

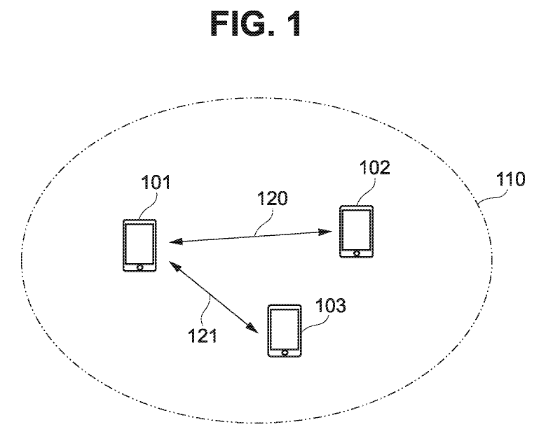

FIG. 1 is a diagram illustrating an example of the configuration of a wireless communication system according to the present embodiment. FIG. 1 illustrates a network formed in the communication system.

The communication system includes two or more communication apparatuses. For example, as illustrated in FIG. 1, the communication system can include a communication apparatus 101, a communication apparatus 102, and a communication apparatus 103. In a case where the communication apparatuses 101, 102, and 103 are not distinguished from each other, the communication apparatuses 101, 102, and 103 are occasionally referred to as "communication apparatuses 100".

Each communication apparatus 100 can be a wireless communication apparatus capable of executing wireless communication compliant with the Institute of Electrical and Electronics Engineers (IEEE) 802.11 standard series including the IEEE 802.11bn standard. The communication apparatus 100 can have a station (STA) function capable of executing wireless communication compliant with the IEEE 802.11 standard series. The communication apparatus 100 may have an access point (AP) function compliant with the IEEE 802.11 standard series. IEEE is the abbreviation of Institute of Electrical and Electronics Engineers. The IEEE 802.11bn standard can also be termed the Ultra High Reliability (UHR) standard. The IEEE 802.11 standard series can include the IEEE 802.11a/b/g/n/ac/ax/be standards. These standards can be termed legacy standards. That is, the communication apparatus 100 is compatible with one or more of the legacy standards in addition to the IEEE 802.11bn standard. Conversely, the communication apparatus 100 may be compatible with one or more of the legacy standards and incompatible with the IEEE 802.11bn standard.

A network 110 formed by the communication apparatus 101 and the communication apparatuses 102 and 103 indicates the range where the communication apparatus 101 and the communication apparatuses 102 and 103 can communicate with each other. That is, in the range of the network 110, the communication apparatuses 102 and 103 can receive signals transmitted from the communication apparatus 101, and the communication apparatus 101 can receive signals transmitted from the communication apparatuses 102 and 103.

Each communication apparatus 100 may also be compatible with another communication standard such as Bluetooth®, near-field communication (NFC), ultra-wideband (UWB), Zigbee®, MultiBand OFDM Alliance (MBOA), or the like in addition to the IEEE 802.11 standard series. NFC is the abbreviation of near-field communication. UWB is the abbreviation of ultra-wideband. MBOA is the abbreviation of MultiBand OFDM Alliance. UWB includes Wireless Universal Serial Bus (USB), Wireless 1394, WiNET, and the like. The communication apparatus 100 may also be compatible with a wired communication standard for a wired local area network (LAN) or the like.

The communication apparatus 100 can also have the function of finding another communication apparatus 100 according to the Wi-Fi Direct (WFD) standard and establishing a communication link. For example, in an establishment procedure compliant with the WFD standard, either one of the communication apparatuses 101 and 102 can serve as a group owner (abbreviated as "GO"), and the other can serve as a client (abbreviated as "CL"). In the present embodiment, the communication apparatus 101 can become a GO, provide communication parameters to the communication apparatuses 102 and 103, and construct (e.g., or form or create) the network 110.

On the other hand, the communication apparatuses 102 and 103 as CLs can receive the communication parameters from the communication apparatus 101 and participate in the network 110. Alternatively, the communication apparatus 102 or 103 may become a GO, and the communication apparatus 101 and the communication apparatus 102 or 103 that does not become the GO may become CLs. Parameters may be passed from the CLs to the GO by a bootstrapping technique. In this case, the communication apparatus 101 can operate as a temporary AP. For example, the communication apparatus 101 informs the other communication apparatuses 100 of a beacon and thereby can notify the other communication apparatuses 100 of communication parameters.

Alternatively, each communication apparatus 100 can have the function of establishing a communication link according to an infrastructure connection.

Although FIG. 1 illustrates the state where three communication apparatuses 100 (e.g., the communication apparatuses 101, 102, and 103) exist, the network 110 may be formed by four or more communication apparatuses 100. At this time, the communication apparatuses 100 may connect to each other, or one of the communication apparatuses 100 may become a hub and connect the other communication apparatuses 100. For example, the network 110 can be constructed based on communication parameters provided by the communication apparatus 101 that serves as an AP, and a plurality of communication apparatuses 100 that serves as STAs can participate in the network 110.

Each communication apparatus 100 may be any electronic device such as a smartphone, a tablet, a mobile phone, a personal computer (PC), a video camera, a headset, a printer, a display, or the like, but is not limited to these. The communication apparatus 101 may be any electronic device such as a wireless LAN router, a PC, or the like, but is not limited to these. Each communication apparatus 100 may be an information processing apparatus such as a wireless chip capable of executing wireless communication compliant with the IEEE 802.11bn standard or the like.

The communication apparatus 100 can communicate using wireless signals in frequency bands such as the 2.4 GHz band, the 3.6 GHz band, the 5 GHz band, the 6 GHz band, the 45 GHz band and the 60 GHz band termed millimeter-wave bands, and the like. The frequency bands used by the communication apparatus 100 are not limited to these, and can be the Sub-1 GHz band or the like. The communication apparatus 100 can also communicate using 20 MHz, 40 MHz, 80 MHz, 160 MHz, 320 MHz, 540 MHz, 640 MHz, 1080 MHz, and 2160 MHz bandwidths. The bandwidths used by the communication apparatus 100 are not limited to these, and can be a 240 MHz bandwidth, a 4 MHz bandwidth, or the like. The IEEE 802.11 standard series defines a frequency channel using a 20 MHz bandwidth as a basic channel in frequency bands such as the 2.4 GHz band, the 5 GHz band, the 6 GHz band, and the like. These standards also define a plurality of channels that can be used in frequency bands such as the 2.4 GHz band, the 5 GHz band, and the 6 GHz band. In these standards, a certain channel can be used in combination with another channel adjacent to the certain channel. In the present embodiment, the use of a certain channel in combination with another channel adjacent to the certain channel is occasionally referred to as "channel bonding". A bundle of channels formed of a single channel or two or more channels adjacent to each other is occasionally referred to as a "communication link" (e.g., or simply as a "link"). That is, a single link formed of two channels having a 20 MHz bandwidth uses a 40 MHz bandwidth. The communication apparatus 100 may be an STA multi-link device (MLD) or an AP MLD compatible with multi-links that simultaneously establishes a plurality of links and communicates. In FIG. 1, a single wireless link (e.g., a link 120) is established between the communication apparatuses 101 and 102, and a single wireless link (e.g., a link 121) is established between the communication apparatuses 101 and 103.

### Apparatus Configuration

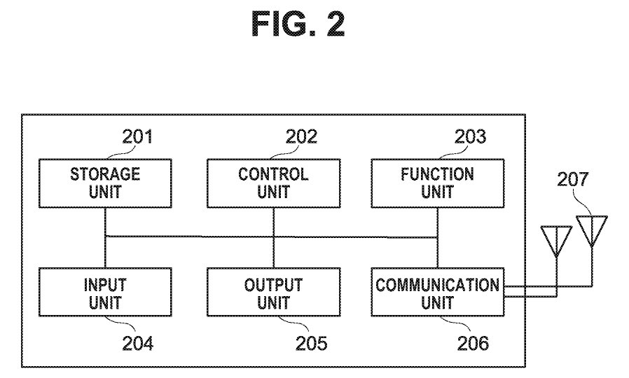

FIG. 2 is a diagram illustrating an example of the hardware configuration of each communication apparatus 100 according to the present embodiment. The communication apparatus 100 includes a storage unit 201, a control unit 202, a function unit 203, an input unit 204, an output unit 205, a communication unit 206, and an antenna 207. As the antenna 207, a single antenna may exist, or a plurality of antennas may exist.

The storage unit 201 includes one or more memories such as a read-only memory (ROM), a random-access memory (RAM), and the like and stores computer programs for performing various operations described below, and various pieces of information such as communication parameters for wireless communication and the like. ROM is the abbreviation of read-only memory. RAM is the abbreviation of random-access memory. As the storage unit 201, in addition to the memories such as the ROM, the RAM, and the like, a storage medium such as a flexible disk, a hard disk, a solid-state drive (SSD), an optical disc, a magneto-optical disc, a compact disc read-only memory (CD-ROM), a compact disc-recordable (CD-R), a magnetic tape, a non-volatile memory card, a digital versatile disc (DVD), or the like may be used. SSD is the abbreviation of solid-state drive. CD-ROM is the abbreviation of compact disc read-only memory. CD-R is the abbreviation of compact disc-recordable. DVD is the abbreviation of digital versatile disc. The storage unit 201 may include a plurality of memories and the like. The storage unit 201 can store setting information input to the communication apparatus 100 by a user, information regarding the state of the communication apparatus 100, such as the remaining amount of a battery included in the communication apparatus 100 and information indicating whether a power saving operation is being executed, and the like.

For example, the control unit 202 includes one or more processors such as a central processing unit (CPU), a microprocessor unit (MPU), and the like and controls the entirety of the communication apparatus 100 by executing a computer program stored in the storage unit 201. CPU is the abbreviation of central processing unit. MPU is the abbreviation of microprocessor unit. The control unit 202 may control the entirety of the communication apparatus 100 by the cooperation of a computer program and an operating system (OS) stored in the storage unit 201. The control unit 202 also generates data and a signal (e.g., a wireless frame) to be transmitted through communication with another communication apparatus 100. The control unit 202 may also include a plurality of processors such as multi-core processors and the like and control the entirety of the communication apparatus 100 using the plurality of processors.

The control unit 202 also controls the function unit 203 to execute a predetermined process such as wireless communication, imaging, printing, projection, or the like. The function unit 203 may be hardware for the communication apparatus 100 to execute the predetermined process. For example, if the communication apparatus 100 is a camera, the function unit 203 is an imaging unit and performs an imaging process. For example, if the communication apparatus 100 is a printer, the function unit 203 is a printing unit and performs a printing process. For example, if the communication apparatus 100 is a projector, the function unit 203 is a projection unit and performs a projection process. Data to be processed by the function unit 203 may be data stored in the storage unit 201, or may be data communicated with another communication apparatus 100 via the communication unit 206.

The input unit 204 receives various operations from the user. The output unit 205 provides various outputs to the user through a monitor screen or a loudspeaker. The outputs provided by the output unit 205 may be display on the monitor screen, the output of a sound from the loudspeaker, the output of a vibration, and the like. Both the input unit 204 and the output unit 205 may be achieved by a single module as in a touch panel. Each of the input unit 204 and the output unit 205 may be integrated with or separate from the communication apparatus 100.

The communication unit 206 controls wireless communication compliant with the IEEE 802.11bn standard. The communication unit 206 may also control wireless communication compliant with another standard of the IEEE 802.11 standard series or control wired communication using a wired LAN or the like in addition to the IEEE 802.11bn standard. The communication unit 206 also controls the antenna 207 to transmit and receive a signal for wireless communication generated by the control unit 202. The communication unit 206 may include a plurality of communication circuits corresponding one-on-one to a plurality of links. In a case where the communication apparatus 100 is compatible with the NFC standard, the Bluetooth® standard, or the like in addition to the IEEE 802.11bn standard, the communication apparatus 100 may control wireless communication compliant with these communication standards. In a case where the communication apparatus 100 can execute wireless communication compliant with a plurality of communication standards, the communication apparatus 100 may individually include a communication unit and an antenna compatible with each communication standard. The communication apparatus 100 communicates data such as image data, document data, video data, or the like with a partner communication apparatus 100 via the communication unit 206.

The antenna 207 and the communication unit 206 may be configured as separate components, or may be configured as a single module.

The wireless antenna 207 is an antenna capable of communicating in the 2.4 GHz band, the 5 GHz band, the 6 GHz band, and the like. In the present embodiment, two or more antennas may exist. If the communication unit 206 includes a plurality of communication units, an antenna corresponding to each of the communication units may exist. Alternatively, a different antenna with respect to each frequency band may exist.

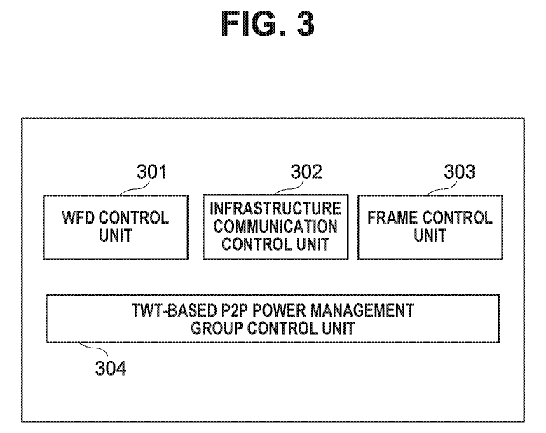

FIG. 3 is a diagram illustrating an example of the functional configuration of each communication apparatus 100 according to the present embodiment. The communication apparatus 100 includes a WFD control unit 301, an infrastructure communication control unit 302, a frame control unit 303, and a Target Wake Time (TWT)-based peer-to-peer (P2P) power management group control unit 304. TWT-based P2P power management (e.g., power management based on TWT) is an example of power management or power saving based on a reduction in or a limitation on a wake time (e.g., in a P2P group or in a direct connection). In the following description, TWT-based P2P power management is abbreviated as "P2P PM". A P2P group may be a network including one or more CLs with which a GO performs WFD communication, and may also be referred to as "a network related to a direct connection" or the like.

The WFD control unit 301 controls WFD communication. For example, the WFD control unit 301 controls or executes a process for finding a partner apparatus according to a frame defined by the WFD standard and exchanging parameters with and connecting to the partner apparatus by Wi-Fi Protected Setup (WPS) or bootstrapping. WPS is the abbreviation of Wi-Fi Protected Setup. For example, the process controlled or executed by the WFD control unit 301 can include a probe process, a service discovery frame (SDF) process, a WPS process, a bootstrapping process, a GO negotiation process, and the like. The WFD control unit 301 also constructs a network (e.g., a P2P group) related to WFD (e.g., a direct connection). The WFD control unit 301 can also transmit a frame related to the WFD communication generated by the frame control unit 303 via the communication unit 206 and the antenna 207 and receive a frame related to the WFD communication from another communication apparatus 100. The WFD control unit 301 is an example of a construction method or a construction unit, a transmission method or a transmission unit, a reception method or a reception unit, a transmission/reception method or a transmission/reception unit, a communication method or a communication unit, or the like.

The infrastructure communication control unit 302 controls infrastructure communication. For example, the infrastructure communication control unit 302 controls or executes a process of finding a partner apparatus using a beacon or the like and connecting to the partner apparatus by an association process. For example, the process controlled or executed by the infrastructure communication control unit 302 can include a probe process, an authentication process, an association process, a 4-way-handshake process, and the like. The infrastructure communication control unit 302 can also transmit a frame related to the infrastructure communication generated by the frame control unit 303 via the communication unit 206 and the antenna 207 and receive a frame related to the infrastructure communication from another communication apparatus 100. The infrastructure communication control unit 302 is an example of a transmission method or a transmission unit, a reception method or a reception unit, a transmission/reception method or a transmission/reception unit, a communication method or a communication unit, or the like.

The frame control unit 303 receives instructions from the WFD control unit 301 and the infrastructure communication control unit 302 and generates frames. The frame control unit 303 is an example of a generation method or a generation unit, or the like.

The P2P PM group control unit 304 determines whether a communication apparatus 100 having transmitted a connection request is allowed to be added to a P2P group that performs P2P PM. The connection request is a request for a direct connection with the communication apparatus 100 including the P2P PM group control unit 304, and for example, is an association request (e.g., a frame). Specifically, the P2P PM group control unit 304 confirms a P2P PM value belonging to a P2P capability extension attribute in the connection request (e.g., the frame) transmitted from the communication apparatus 100. The P2P PM value is included in a capability info field of the P2P capability extension attribute. The P2P PM value being 1 indicates that the communication apparatus 100 supports P2P PM. The P2P PM value being 0 indicates that the communication apparatus 100 does not support P2P PM. Then, according to the P2P PM value, the P2P PM group control unit 304 determines whether the communication apparatus 100 is allowed to be added to the P2P group. Specifically, if the P2P PM value is 1, the P2P PM group control unit 304 determines that the communication apparatus 100 is allowed to be added to the P2P group. If, on the other hand, the P2P PM value is 0, the P2P PM group control unit 304 determines that the communication apparatus 100 is not allowed to be added to the P2P group. In other words, the P2P PM group control unit 304 determines that the communication apparatus 100 is to be prevented from participating in the P2P group. Or the P2P PM group control unit 304 performs control to prevent the communication apparatus 100 from participating in the P2P group. The P2P capability extension attribute is included in the following frames and the like. These frames are a beacon frame, a probe request/response frame, an association request/response frame, and a Go negotiation request/response frame. In this case, "/" means "and/or". The P2P PM group control unit 304 is an example of a network control method or a network control unit, a determination method or a determination unit, a determining method or a determining unit, or the like.

Only a communication apparatus 100 having the following functions (e.g., the communication apparatus 101 among the communication apparatuses 101, 102, and 103) may include the P2P PM group control unit 304.
The communication apparatus 100 can perform WFD communication.
The communication apparatus 100 can construct (e.g., form) a network (e.g., a P2P group) (e.g., can operate as a GO).
The communication apparatus 100 supports P2P PM.

### OPERATIONS

Next, a description is given of various operations of the flow of processing executed by each communication apparatus 100, a processing sequence in the wireless communication system, and the like.

### Example 1

In example 1, the communication apparatus 101 operates as a GO, and the communication apparatuses 102 and 103 operate as CLs.

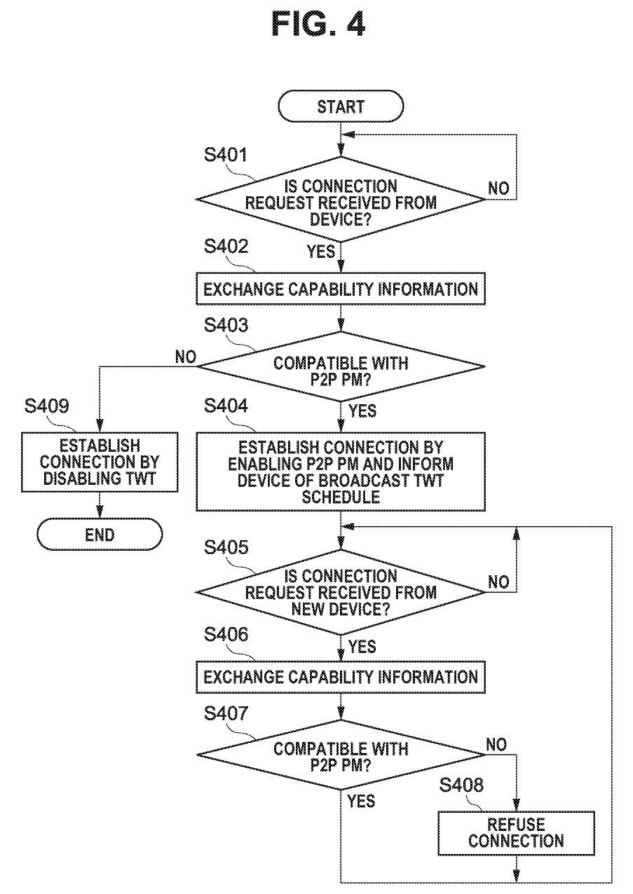

FIG. 4 is a flowchart illustrating an example of the flow of a process for forming a P2P group in which the communication apparatus 101 performs P2P PM. This example is based on the premise that the control unit 202 of the communication apparatus 101 starts the communication unit 206 of the communication apparatus 101 as the GO and causes the communication unit 206 of the communication apparatus 101 to transmit a beacon frame. For example, the processing illustrated in FIG. 4 may be executed by the control unit 202 of the communication apparatus 101 executing a program stored in the storage unit 201 of the communication apparatus 101.

First, in step S401, the communication unit 206 of the communication apparatus 101 (hereinafter, simply "the communication unit 206") receives a connection request from the communication apparatus 102. At this time, in step S402, the communication apparatuses 101 and 102 exchange capability information through the beacon frame, the connection request, or the like. Capability information regarding P2P is termed a P2P capability extension attribute. The P2P capability extension attribute included in the above frame or the like includes information enabling the determination of whether the communication apparatus 100 having transmitted the above frame or the like is compatible with P2P PM. The expression "whether the communication apparatus 100 is compatible with P2P PM" may be replaced by the expression "whether the communication apparatus 100 supports P2P".

In step S403, the communication unit 206 notifies the control unit 202 of the communication apparatus 101 (hereinafter, simply "the control unit 202") of the received connection request, and based on the connection request of which the control unit 202 is notified, the control unit 202 determines whether the communication apparatus 102 is compatible with P2P PM.

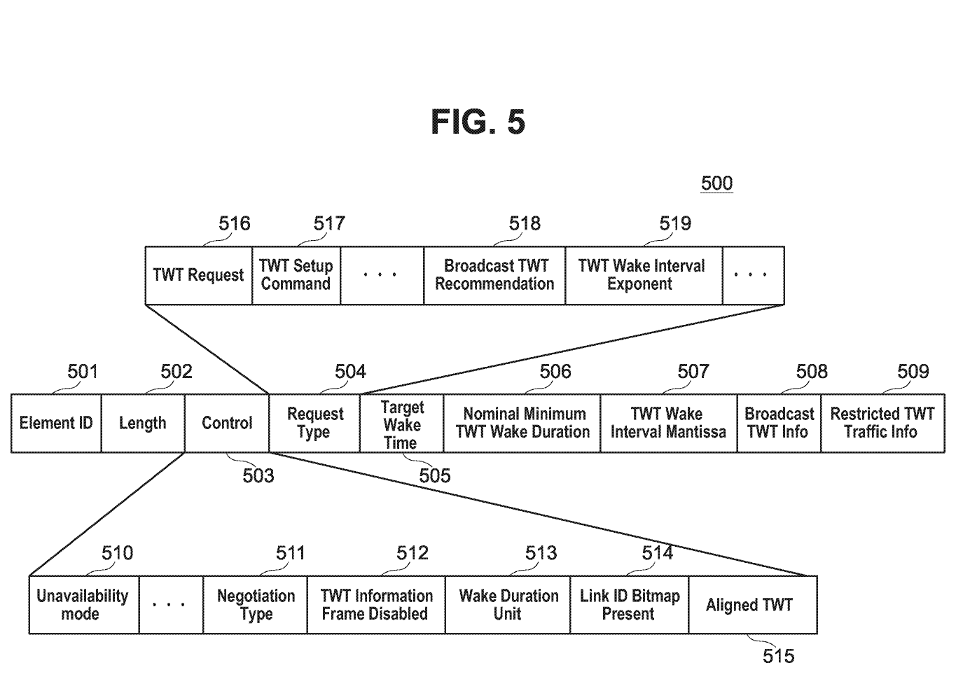

If the control unit 202 determines that the communication apparatus 102 is compatible with P2P PM (Yes in step S403), then in step S404, the control unit 202 performs the following control. That is, in step S404, the control unit 202 notifies the communication unit 206 that the communication unit 206 is to enable P2P PM and transmit a beacon frame by including a broadcast TWT schedule, and the communication unit 206 transmits the beacon frame. Consequently, the communication apparatuses 101 and 102 can be synchronized with each other in power saving states. Further, in step S404, the control unit 202 establishes a connection with the communication apparatus 102 via the communication unit 206. In this manner, the control unit 202 constructs a P2P group according to the information included in the connection request and enabling the determination of whether the communication apparatus 100 is compatible with P2P PM. The broadcast TWT schedule will be described below with reference to FIG. 5.

After the control unit 202 establishes the connection with the communication apparatus 102, then in step S405, the communication unit 206 receives a connection request as a new connection request from the communication apparatus 103. In step S406, similarly to step S402, the communication apparatuses 101 and 103 exchange capability information through the beacon frame, the connection request, or the like. In step S407, similarly to step S403, the communication unit 206 notifies the control unit 202 of the received connection request, and based on the connection request of which the control unit 202 is notified, the control unit 202 determines whether the communication apparatus 103 is compatible with P2P PM.

If the control unit 202 determines that the communication apparatus 103 is compatible with P2P PM (Yes in step S407), then, as in step S404, the control unit 202 establishes a connection with the communication apparatus 103 via the communication unit 206. Then, the processing returns to step S405.

If, on the other hand, the control unit 202 determines that the communication apparatus 103 is not compatible with P2P PM (No in step S407), then in step S408, the control unit 202 transmits information indicating that a connection is refused (e.g., a response to the connection request) to the communication apparatus 103 via the communication unit 206. Then, the processing returns to step S405.

If the control unit 202 determines in step S403 that the communication apparatus 102 is not compatible with P2P PM (No in step S403), then in step S409, the control unit 202 performs the following control. That is, in step S409, the control unit 202 notifies the communication unit 206 that the communication unit 206 is to disable P2P PM and transmit a beacon frame by including a broadcast TWT schedule, and the communication unit 206 transmits the beacon frame. Further, in step S409, the control unit 202 establishes a connection with the communication apparatus 102 via the communication unit 206 in the state where TWT is disabled.

Alternatively, if the control unit 202 determines in step S407 in this example that the communication apparatus 103 is not compatible with P2P PM (No in step S407), the control unit 202 may operate similarly to step S409. That is, the control unit 202 may notify the communication unit 206 that the communication unit 206 is to disable P2P PM and transmit a beacon frame by including a broadcast TWT schedule, and the communication unit 206 may transmit the beacon frame. Further, the control unit 202 may establish a connection with the communication apparatus 103 via the communication unit 206 in the state where TWT is disabled. At this time, the control unit 202 may establish a connection with the communication apparatus 102 via the communication unit 206 in the state where TWT is disabled.

FIG. 5 is a diagram illustrating an example of the configuration of a TWT element. A TWT element 500 illustrated in FIG. 5 includes the broadcast TWT schedule described with reference to FIG. 4.

The TWT element 500 includes an element ID field 501, a length field 502, a control field 503, a request type field 504, and a Target Wake Time field 505. The TWT element 500 also includes a nominal minimum TWT wake duration field 506 and a TWT wake interval mantissa field 507. The TWT element 500 also includes a broadcast TWT info field 508 and a restricted TWT traffic info field 509.

The element ID field 501 stores 216 as a value indicating that the TWT element 500 is a TWT element.

The length field 502 is a field indicating the length of the element in and after the length field 502.

The control field 503 is a field for presenting the type of a TWT element field and the presence or absence of a subsequent field. The control field 503 includes an unavailability mode sub-field 510 and a negotiation type sub-field 511. The control field 503 also includes a TWT information frame disabled sub-field 512 and a wake duration unit sub-field 513. The control field 503 also includes a link ID bitmap present sub-field 514 and an aligned TWT sub-field 515.

The unavailability mode sub-field 510 is a field indicating whether the TWT element 500 is in an unavailability mode. The value of the unavailability mode sub-field 510 being 1 indicates that the TWT element 500 is in the unavailability mode. The value of the unavailability mode sub-field 510 being 0 indicates that the TWT element 500 is not in the unavailability mode. In the present embodiment, the value of the unavailability mode sub-field 510 is 0.

The negotiation type sub-field 511 is a field indicating whether TWT parameters (i.e., the TWT element 500) are for all (e.g., broadcast) or for an individual. The negotiation type sub-field 511 is also a field indicating whether a wake target beacon transmission time (TBTT) interval is indicated. In the present embodiment, the TWT element 500 is a TWT element for an individual, and therefore, the value of the negotiation type sub-field 511 is 0.

The TWT information frame disabled sub-field 512 is a field indicating whether to cancel (e.g., disable) TWT Information received by an STA. In the present embodiment, the value of the TWT information frame disabled sub-field 512 is 0 indicating that TWT Information received by an STA is not to be cancelled (e.g., not to be disabled).

The wake duration unit sub-field 513 is a field indicating the unit of time indicated by the nominal minimum TWT wake duration field 506. If the value of the wake duration unit sub-field 513 is 1, the unit is 256 µs. If the value of the wake duration unit sub-field 513 is 0, the unit is 1 time unit (TU). In the present embodiment, the value of the wake duration unit sub-field 513 is 1.

The link ID bitmap present sub-field 514 is a field indicating whether a link ID bitmap field is present. If a link ID bitmap field is not present, the TWT element 500 is enabled only in a link of which the TWT element 500 is notified. If a link ID bitmap field is present, the TWT element 500 is enabled in a link indicated by the link ID bitmap field. In the present embodiment, a link ID bitmap field is not present, and therefore, the value of the link ID bitmap present sub-field 514 is 0.

The aligned TWT sub-field 515 is a field indicating whether an aligned TWT link bitmap field used in a case where negotiations on TWT elements in a plurality of links are collectively made is present. In the present embodiment, an aligned TWT link bitmap field is not present, and therefore, the value of the aligned TWT sub-field 515 is 0.

The request type field 504 stores a parameter indicating the request type of the TWT element 500. If the value of the unavailability mode sub-field 510 is 0 (i.e., in the present embodiment), the request type field 504 includes the following sub-fields. That is, the request type field 504 includes a TWT request sub-field 516 and a TWT setup command sub-field 517. The request type field 504 also includes a broadcast TWT recommendation sub-field 518 and a TWT wake interval exponent sub-field 519.

The TWT request sub-field 516 is a field indicating whether the communication apparatus 100 requests or demands the values indicated by the TWT element 500 or TWT is scheduled for the communication apparatus 100.

The TWT setup command sub-field 517 is a field indicating the negotiation type of the frame in which the TWT element 500 is provided. The value of the TWT setup command sub-field 517 being 0 indicates request. The value of the TWT setup command sub-field 517 being 1 indicates suggest. Suggest ("1") is specified in a case where a suggestion is to be made to the partner apparatus. The value of the TWT setup command sub-field 517 being 2 indicates demand. Demand ("2") is specified in a case where a request is to be made to the partner apparatus. The value of the TWT setup command sub-field 517 being 3 indicates TWT grouping. TWT grouping ("3") is specified in a case where replies are to be collectively made to a plurality of different STAs. The value of the TWT setup command sub-field 517 being 4 indicates accept. Accept ("4") is specified in a case where a request from the partner apparatus is to be accepted. The value of the TWT setup command sub-field 517 being 5 indicates alternate. Alternate ("5") is specified in a case where an operation is to be performed with a different setting from suggest or demand from the partner apparatus, and the different setting is to be demanded from the partner apparatus. The value of the TWT setup command sub-field 517 being 6 indicates dictate. Dictate ("6") is specified in a case where an operation is to be performed with a different setting from suggest or demand from the partner apparatus, and the different setting is to be presented to the partner apparatus.

The broadcast TWT recommendation sub-field 518 is a field indicating whether there is a recommendation for a frame to be transmitted (e.g., broadcast) during a TWT service period (SP), and indicating a frame recommended in a case where there is a recommendation.

The value of the broadcast TWT recommendation sub-field 518 being 0 indicates that a frame to be transmitted is not limited.

The value of the broadcast TWT recommendation sub-field 518 being 1 indicates that it is recommended that a frame to be transmitted be limited to the following frames.
A PS-Poll frame and a QoS null frame
QoS control feedback
A high efficiency (HE) trigger-based (TB) feedback NDP (null data PHY protocol data unit (PPDU))
A bandwidth query report (BQR)
A buffer status report (BSR).
Sounding
A management frame
A control response frame

The value of the broadcast TWT recommendation sub-field 518 being 2 indicates that it is recommended that a frame to be transmitted be limited to the above frames except for the HE TB feedback NDP.

The value of the broadcast TWT recommendation sub-field 518 being 3 indicates that there are no limitations on frames except for the following frames.

A traffic indication map (TIM) frame

A fast initial link setup (FILS) discovery frame including a TIM element

The TWT wake interval exponent sub-field 519 is a field indicating the length of a period between periods when communication parameters are limited, together with the TWT wake interval mantissa field 507. The above period is a TWT SP specified by the TWT element 500. In the present embodiment, the length of the period between the periods when communication parameters are limited is referred to as a "TWT wake interval", and the unit of the TWT wake interval is μs. Specifically, 2 is exponentiated by a value indicated by the TWT wake interval exponent sub-field 519, and a value obtained by multiplying the result of the exponentiation by a value indicated by the field 507 is the TWT wake interval. During a period other than the TWT SP at the TWT wake interval, the communication apparatus 100 may transition to a sleep state (e.g., or a doze state). In the sleep state, the communication apparatus 100 does not execute transmission and reception (e.g., communication). In this case, the period other than the TWT SP at the TWT wake interval may be referred to as "the period when communication cannot be performed" or "the period when communication is impossible". Alternatively, during the period other than the TWT SP at the TWT wake interval, the communication apparatus 100 may not transition to the sleep state (e.g., or the doze state).

In this case, during the period other than the TWT SP at the TWT wake interval, the communication apparatus 100 may execute transmission and reception (e.g., communication).

The Target Wake Time field 505 is a field indicating by an 8-octet length a timing synchronization function (TSF) time transmitted using a beacon by an AP at the start time of the TWT SP when the AP wakes (e.g., operates) (e.g., is in an awake state or an active state) and communicates. TSF is the abbreviation of timing synchronization function. If the value of the TWT setup command sub-field 517 is 2, 3, or 4, the Target Wake Time field 505 may not be present. If the value of the TWT setup command sub-field 517 is 0 or 1, the Target Wake Time field 505 indicates by an 8-octet length the TSF time of the AP at the start time when communication parameters are limited.

The nominal minimum TWT wake duration field 506 is a field indicating the length of the TWT SP in the unit indicated by the wake duration unit sub-field 513.

The broadcast TWT info field 508 includes a broadcast TWT ID and broadcast TWT persistence. The broadcast TWT ID stores the identifier of broadcast TWT as a target in a case where an STA (e.g., the communication apparatuses 102 and 103) to which transmission is to be performed requests (e.g., demands) participation or specifies TWT to be provided. The broadcast TWT persistence indicates the value of TBTT in which broadcast TWT is present. The broadcast TWT schedule described with reference to FIG. 4 corresponds to the broadcast TWT info field 508.

The restricted TWT traffic info field 509 is used to specify whether an STA other than an STA as a target is allowed to perform transmission. The restricted TWT traffic info field 509 may not be present. The value of the restricted TWT traffic info field 509 being 0 indicates that there is not an STA that participates in restricted TWT. The value of the restricted TWT traffic info field 509 being 1 indicates that one or more STAs participate in restricted TWT. The value of the restricted TWT traffic info field 509 being 2 indicates that new restricted TWT is less likely to be accepted. The value of the restricted TWT traffic info field 509 being 3 indicates that a non-transmitted basic service set identifier (BSSID) executes restricted TWT.

While an example of the configuration of the TWT element including the broadcast TWT schedule described with reference to FIG. 4 has been described above, the TWT element has the same configuration as or a similar configuration to the configuration described above with reference to FIG. 5 also in the following examples.

As described above, according to example 1, the communication apparatus 101 as a GO can form a P2P group that performs TWT-based P2P power management (P2P PM). The communication apparatus 101 confirms whether a communication apparatus 100 having transmitted a connection request supports P2P PM. If the communication apparatus 100 having transmitted the connection request supports P2P PM, the communication apparatus 101 permits the communication apparatus 100 to participate in or connect to the existing P2P group. In contrast, if the communication apparatus 100 having transmitted the connection request does not support P2P PM, the communication apparatus 101 refuses the participation of the communication apparatus 100 in or the connection of the communication apparatus 100 to the existing P2P group. Consequently, it is possible to maintain the P2P group that supports (e.g., performs) P2P PM. Thus, it is possible to prevent or reduce an increase in power consumption.

If the communication apparatus 102 or 103 that does not support P2P PM confirms that the communication apparatus 101 supports P2P PM based on a beacon frame from the communication apparatus 101 as the GO, the communication apparatus 102 or 103 may operate as follows. That is, the output unit 205 of the communication apparatus 102 or 103 may not display a button for executing a process of connecting to the communication apparatus 101 (e.g., a button for transmitting a connection request from the communication apparatus 102 or 103 to the communication apparatus 101 or the like). Consequently, the communication apparatus 102 or 103 does not need to attempt to make an unnecessary connection with the communication apparatus 101 in a case where the communication apparatus 102 or 103 does not support P2P PM.

### Example 2

In example 2, similarly to example 1, the communication apparatus 101 operates as a GO, and the communication apparatuses 102 and 103 operate as CLs.

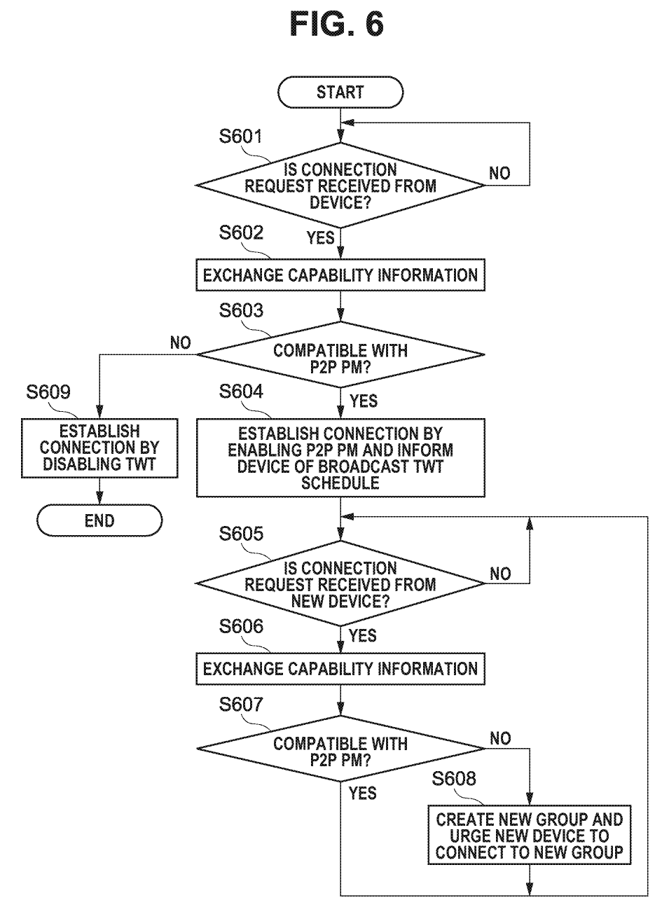

FIG. 6 is a flowchart illustrating an example of the flow of a process for forming a P2P group in which the communication apparatus 101 performs P2P PM. This example is based on the premise that the control unit 202 of the communication apparatus 101 starts the communication unit 206 of the communication apparatus 101 as the GO and causes the communication unit 206 of the communication apparatus 101 to transmit a beacon frame. For example, the processing illustrated in FIG. 6 may be executed by the control unit 202 of the communication apparatus 101 executing a program stored in the storage unit 201 of the communication apparatus 101.

Step S601 to S607 and S609 illustrated in FIG. 6 are similar to steps S401 to S407 and S409, respectively, illustrated in FIG. 4, and therefore are not described.

If the control unit 202 determines that the communication apparatus 103 is compatible with P2P PM (Yes in step S607), then, as in step S604, the control unit 202 establishes a connection with the communication apparatus 103 via the communication unit 206. Then, the processing returns to step S605.

If, on the other hand, the control unit 202 determines that the communication apparatus 103 is not compatible with P2P PM (No in step S607), then in step S608, the control unit 202 performs the following control. That is, in step S608, the control unit 202 transmits information indicating that a connection is refused (e.g., a response to the connection request) to the communication apparatus 103 via the communication unit 206. Further, in step S608, the control unit 202 constructs a P2P group that does not support P2P PM. Consequently, in step S608, the control unit 202 separately constructs the P2P group that does not support P2P PM, and the communication unit 206 transmits information urging the communication apparatus 103 to participate in or connect to the newly constructed P2P group to the communication apparatus 103. Then, the processing returns to step S605. The communication apparatus 103 participates in or connects to the newly constructed P2P group.

As described above, according to example 2, similarly to example 1, the communication apparatus 101 as a GO can form a P2P group that performs TWT-based P2P power management (P2P PM). The communication apparatus 101 confirms whether a communication apparatus 100 having transmitted a connection request supports P2P PM. If the communication apparatus 100 having transmitted the connection request supports P2P PM, the communication apparatus 101 permits the communication apparatus 100 to participate in or connect to the existing P2P group. In contrast, if the communication apparatus 100 having transmitted the connection request does not support P2P PM, the communication apparatus 101 refuses the participation of the communication apparatus 100 in or the connection of the communication apparatus 100 to the existing P2P group and also constructs a P2P group that does not support P2P PM. Consequently, the communication apparatus 100 the connection of which is refused is urged to participate in or connect to the newly constructed P2P group, whereby it is possible to maintain the P2P group that supports (e.g., performs) P2P PM.

Thus, it is possible to prevent or reduce an increase in power consumption.

In this example, if the communication apparatus 101 receives a connection request from a communication apparatus 100 that does not support P2P PM, the communication apparatus 101 may cancel or end the P2P group that supports (e.g., performs) P2P PM. Then, the communication apparatus 101 may construct a P2P group that does not support P2P PM, and connect the communication apparatus 100 having transmitted the connection request to the constructed P2P group. Then, the communication apparatus 101 may construct the P2P group that supports P2P PM again. At this time, a communication apparatus 100 that has been in or connected to the cancelled or ended P2P group participates in or connects to the P2P group constructed again, whereby it is possible to resume the P2P group that supports P2P PM.

### Other Embodiments

The placement of the above fields (e.g., including sub-fields) is not limited to the example illustrated in the figure in the present disclosure, and these fields may be placed in another order. The above frame may not include all the fields illustrated in the figure in the present disclosure, and may include only some of the fields. To the above frame, another field different from the fields illustrated in the figure in the present disclosure may be added.

The combination of the value of each field and the corresponding meaning (e.g., the indication provided by the value) is not limited to the above example. For example, regarding a 1-bit field, the value "1" and the value "0" may have opposite meanings.

A storage medium storing a program code of software for achieving the above functions may be supplied to a system or an apparatus, and a computer (a CPU or an MPU) of the system or the apparatus may read and execute the program code stored in the storage medium. In this case, the program code itself read from the storage medium achieves the functions of the above embodiments, and the storage medium storing the program code constitutes the above apparatus.

As the storage medium for supplying the program code, for example, a flexible disk, a hard disk, an optical disc, a magneto-optical disc, a CD-ROM, a CD-R, a magnetic tape, a non-volatile memory card, a ROM, a DVD, or the like can be used.

Not only may the above functions be achieved by executing the program code read by the computer, but also the above functions may be achieved by an OS, while operating on the computer, performing a part or all of actual processing based on an instruction from the program code.

Further, the program code read from the storage medium may be written to a memory included in a function extension board inserted into the computer or a function extension unit connected to the computer.

Then, a CPU included in the function extension board or the function extension unit may perform a part or all of actual processing based on an instruction from the program code, thereby achieving the above functions.

The present disclosure can also be achieved by the process of supplying a program for achieving one or more functions of the above embodiments to a system or an apparatus via a network or a storage medium, and of causing one or more processors of a computer of the system or the apparatus to read and execute the program. The present disclosure can also be achieved by a circuit (e.g., an application-specific integrated circuit (ASIC)) for achieving the one or more functions.

A part of the processing described with reference to the flowcharts in the present disclosure may be achieved by hardware. For example, a dedicated circuit may be automatically generated on a field-programmable gate array (FPGA) according to a program for achieving steps, using a predetermined compiler. Alternatively, a gate array circuit may be formed similarly to the FPGA and achieved as hardware.

The names of the functional blocks, the messages, the parameters, the fields, and the like described in the above embodiments may be changed to other names.

The orders in the processing procedures, the sequences, the flowcharts, and the like in the above embodiments are not limited to the presented particular orders, and may be replaced, or additional steps may be added, unless there is a contradiction. Alternatively, some steps may be omitted.

The features illustrated in the above embodiments and the features illustrated in the attached drawings can each be regarded as an independent element having a unique technical contribution. In other words, while these features exert a synergistic effect in the context of the above detailed descriptions, these features are not limited to such combinations, and can be individually extracted and independently used to address a particular issue or enhance a particular function. Further, the specific embodiments presented in the above detailed descriptions can include many variations. These embodiments are merely illustrative, and do not limit the scope, the applicability, the control, or the configuration of the present disclosure in any way. The above detailed descriptions rather provide an example of a guide for a person skilled in the art to implement an embodiment that can be carried out. To sum up, the operations, the methods, the steps, the units, and the schemes described in the above detailed descriptions can be changed in various ways without departing from the scope of the appended claims. In other words, subject matter including a component in a form in which the operations, the steps, the units, the schemes, and the like in a part of the above embodiments are replaced, changed, reconfigured, dismantled, and/or combined is also assumed as patent-eligible subject matter that can have the unique technical contribution in the present disclosure. Further, subject matter composed of a component in a form in which the operations, the steps, the units, the schemes, and the like in a part of the above embodiments are deleted is also assumed as patent-eligible subject matter that can have the unique technical contribution in the present disclosure. Then, subject matter composed of a component in a form in which a part of the above embodiments is replaced, changed, reconfigured, dismantled, and/or combined and another part of the above embodiments is deleted is also assumed as patent-eligible subject matter that can have the unique technical contribution in the present disclosure.

Based on the above, it is possible to prevent a communication apparatus that does not support TWT-based P2P power management from participating in a P2P group that supports TWT-based P2P power management. Consequently, it is possible to prevent or reduce an increase in power consumption of a communication apparatus that supports TWT-based P2P power management.

According to an aspect of the present disclosure, it is possible to prevent or reduce an increase in power consumption.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-067907, filed Apr. 17, 2025, which is hereby incorporated by reference herein in its entirety.

What is claimed is:

1. A communication apparatus configured to establish a direct connection with another communication apparatus and construct a network related to the direct connection, the communication apparatus comprising:
at least one memory that stores a set of instructions; and
at least one processor that executes the instructions, the instructions, when executed, causing the communication apparatus to perform operations comprising:
receiving, from a first other communication apparatus, first information indicating whether the first other communication apparatus supports power saving based on a reduction in a wake time.

2. The communication apparatus according to claim 1, wherein the receiving comprises receiving a request for a direct connection with the communication apparatus from the first other communication apparatus, the request including the first information.

3. The communication apparatus according to claim 2, wherein the operations further comprise, in a case where the first information indicates that the first other communication apparatus does not support power saving based on a reduction in the wake time, transmitting, to the first other communication apparatus, in response to the request, a response indicating refusal of the direct connection.

4. The communication apparatus according to claim 1, wherein the operations further comprise, in a case where the first information indicates that the first other communication apparatus does not support power saving based on a reduction in the wake time, performing control to prevent the first other communication apparatus from participating in a first network related to a direct connection supporting power saving based on a reduction in the wake time.

5. The communication apparatus according to claim 4, wherein the operations further comprise constructing the first network.

6. The communication apparatus according to claim 5,
wherein, before receiving the first information, the receiving, from a second other communication apparatus, second information indicating that the second other communication apparatus supports power saving based on a reduction in the wake time, and
wherein the constructing comprise constructing the first network according to the second information.

7. The communication apparatus according to claim 5, wherein, in a case where the first information indicates that the first other communication apparatus does not support power saving based on a reduction in the wake time, the constructing a second network related to a direct connection that allows the first other communication apparatus that does not support power saving based on a reduction in the wake time to participate.

8. The communication apparatus according to claim 7, wherein, in a case where the first information indicates that the first other communication apparatus does not support power saving based on a reduction in the wake time, the constructing comprises terminating the first network before constructing the second network.

9. The communication apparatus according to claim 8, wherein, in a case where the first information indicates that the first other communication apparatus does not support power saving based on a reduction in the wake time, and after constructing the second network, the constructing further comprises constructing a third network related to a direct connection that allows one or more other communication apparatuses that support power saving based on a reduction in the wake time and have participated in the first network to participate.

10. A control method for controlling a communication apparatus configured to establish a direct connection with another communication apparatus and construct a network related to the direct connection, the control method comprising:
receiving, from a first other communication apparatus, first information indicating whether the first other communication apparatus supports power saving based on a reduction in a wake time.

11. A non-transitory computer-readable storage medium storing instructions that, when executed by a computer, cause the computer to perform a control method for controlling a communication apparatus configured to establish a direct connection with another communication apparatus and construct a network related to the direct connection, the control method comprising:
receiving, from a first other communication apparatus, first information indicating whether the first other communication apparatus supports power saving based on a reduction in a wake time.
